(19) United States
(12) Patent Application Publication
(10) Pub. No.: US 2025/0137111 A1
(43) Pub. Date: May 1, 2025

(54) Gas Shield Protection Device for Thermal Spraying

(71) Applicant: METAL INDUSTRIES RESEARCH & DEVELOPMENT CENTRE, Kaohsiung City (TW)

(72) Inventors: Yue-Jun Wang, New Taipei City (TW); Chi-An Chen, Taipei City (TW); Shu-Feng Lee, Tainan City (TW); Chun-Chieh Tseng, Kaohsiung City (TW); Tung-Lin Tsai, Tainan City (TW); Bol-Wei Huang, Kaohsiung City (TW)

(21) Appl. No.: 18/498,600

(22) Filed: Oct. 31, 2023

(51) Int. Cl. C23C 4/01; B05B 12/18

(52) U.S. Cl. CPC C23C 4/01; B05B 12/18

(57) ABSTRACT

A gas shield protection device for thermal spraying includes a spraying member and a gas shield generation device. The spraying member includes a nozzle and a shield body disposed on the nozzle. The nozzle is configured to align with one of a plurality of workpieces on a worktable. The gas shield generation device is configured to align with the worktable and includes a housing and a second gas ejection portion. The housing has a gas passageway therein. The second gas ejection portion has at least one gas ejection port intercommunicating with the gas passageway. The at least one gas ejection port is configured to face the plurality of workpieces, such that an area of a gas shield ejected from the at least one gas ejection port of the second gas ejection portion covers the plurality of workpieces. Thus, oxidation of the coating on the workpiece can be avoided.

### BACKGROUND OF THE INVENTION

### 1. Field of the Invention

The present invention relates to a thermal spraying isolation device for workpieces and, more particularly, to a gas shield protection device for thermal spraying to isolate the workpieces from the atmosphere during thermal spraying process.

### 2. Description of the Related Art

Thermal spraying is a technique using heat sources. For example, plasma or electric arc heats a spray material to a molten or semi-molten state, and the spray material is ejected at a certain speed so as to be deposited on the surface of a predetermined workpiece to form a coating. This provides the predetermined workpiece with functionalities including anti-corrosion, abrasion resistance, high temperature resistance, anti-oxidation, thermal insulation, electrical insulation, electrical conductivity, and anti-microwave radiation. In the field of medical therapy, plasma spraying is generally used to spray hydroxyapatite (HA) on a surface of a medical device (such as a surgical tool or an implant) to provide the surgical tool or implant with excellent biocompatibility, thereby reducing the risk of human body reject reaction.

However, regulations (IS013179-1) regarding cleanness and oxidation extent of the sprayed coating are required when plasma spraying is used on medical devices. Thus, the nozzle of the spraying device is provided with a thermal spraying gas protection device which can eject protective gas to form a gas shield surrounding the nozzle of the spraying nozzle, thereby providing isolation from the atmosphere through provision of the gas shield. This avoids oxygen from being mixed into the material during the spraying process, thereby avoiding oxidation of the coating of the medical device. However, the gas shield is near the nozzle, such that the gas currents forming the gas shield tend to interfere with the gas current path of material ejected from the nozzle. As a result, the coating accuracy of the medical device is not good.

Furthermore, during the spraying process on the medical device, intermittent spraying is generally adopted to avoid meltdown of the medical device due to long-term contact with the plasma. Namely, repeated spraying is carried out on the medical device at a predetermined interval, and the medical device contacts with the atmosphere during the interval. Thus, the coating is apt to oxidize, such that the medical device has a poor spraying effect or even cannot be used due to failure to meet the regulations.

Thus, it is necessary to improve the conventional gas shield protection device for thermal spraying.

### SUMMARY OF THE INVENTION

To solve the above problem, it is an objective of the present invention to provide a gas shield protection device for thermal spraying which can reduce interference to the gas currents for spraying material.

It is another objective of the present invention to provide a gas shield protection device for thermal spraying which can avoid contact with the atmosphere during the spraying process.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

As used herein, the term “engagement”, “coupling”, “assembly”, or similar terms is used to include separation of connected members without destroying the members after connection or inseparable connection of the members after connection. A person having ordinary skill in the art would be able to select according to desired demands in the material or assembly of the members to be connected.

A gas shield protection device for thermal spraying according to the present invention includes a spraying member and a gas shield generation device. The spraying member includes a nozzle and a shield body disposed on the nozzle. The nozzle is configured to align with one of a plurality of workpieces on a worktable. The shield body includes an end face having a through-hole aligned with an opening of the nozzle. A first gas ejection portion is disposed around the through-hole and includes at least one gas ejection port located on the end face. The first gas ejection portion includes at least one first guiding protrusion located between the at least one gas ejection port and the through-hole. The at least one guiding protrusion has a guiding face located on a side of the at least one guiding protrusion facing the at least one gas ejection port. The guiding face a is configured to avoid gas currents ejected from the first gas ejection portion from overlapping with a path of a spray material ejected from the opening of the nozzle. The gas shield generation device is configured to align with the worktable. The gas shield generation device includes a housing and a second gas ejection portion. The housing has a gas passageway therein. The second gas ejection portion has at least one gas ejection port intercommunicating with the gas passageway. The at least one gas ejection port is configured to face the plurality of workpieces, such that an area of a gas shield ejected from the at least one gas ejection port of the second gas ejection portion covers the plurality of workpieces.

Therefore, in the gas shield protection device for thermal spraying according to the present invention, by providing the first gas ejection portion having at least one guiding protrusion located between the at least one gas ejection port and the through-hole, such that the at least one guiding protrusion forms the guiding face with respect to the at least one gas ejection port. The guiding face permits the path of the gas currents ejected from the at least one gas ejection port to be parallel to or deviate from the path of the spray material. This avoids the path of the gas currents ejected from the at least one gas ejection port from interfering with the path of the spray material, thereby achieving better spraying accuracy. Furthermore, the second gas ejection portion can generate a protective gas to cover the workpieces, such that the workpieces before the spraying process can be temporarily located in the gas shield and, thus, can be isolated from the atmosphere, thereby avoiding oxidation of the coating on the workpieces.

In an example, the at least one gas ejection port of the first gas ejection portion includes a plurality of gas ejection ports disposed around the through-hole and spaced from each other. Thus, the protective gas ejected from the plurality of gas ejection ports can surround the through-hole to isolate the through-hole from the atmosphere.

In an example, each of the plurality of gas ejection ports of the first gas ejection portion has a flow passage. Each flow passage of the first gas ejection portion has a diffusion angle toward a respective gas ejection port. The diffusion angle is 10-90 degrees. Thus, each flow passage gradually expands toward the respective gas ejection port, such that the areas covered by the gas currents ejected from two adjacent gas ejection ports can overlap with each other, which reliably forms a gas shield to completely isolate the through-hole from the atmosphere.

In an example, the at least one gas ejection port of the first gas ejection portion includes an annular gas ejection port disposed around the through-hole to form an annular opening. Thus, the gas ejection port can send out an annular gas shield surrounding the through-hole to further assure isolation of the through-hole from the atmosphere.

In an example, a protruding distance of the at least one guiding protrusion protruding from the end face is at least 5 mm. Thus, the at least one guiding protrusion has enough protruding distance to provide a guiding effect for the gas currents ejected from the at least one gas ejection port.

In an example, the guiding face extends perpendicularly to the at least one gas ejection port of the first gas ejection portion. Thus, the gas currents ejected from the at least one gas ejection port can be guided by the guiding face to move forward in a path parallel to the path of the spray material.

In an example, the guiding face has an inclination angle toward the at least one gas ejection port of the first gas ejection portion, and the inclination angle is 5-45 degrees. Thus, the gas currents ejected from the at least one gas ejection port can be guided by the guiding face to deviate from the path of the spray material.

In an example, the at least one gas ejection port of the second gas ejection portion includes a plurality of gas ejection ports spaced from each other. Two gas shields ejected from two adjacent gas ejection ports of the second gas ejection portion overlap with each other. Thus, the protective gas ejected from the plurality of gas ejection ports can surround the workpieces to thereby isolate the workpieces from the atmosphere.

In an example, a spacing between two adjacent gas ejection ports of the second gas ejection portion is 50-200 mm, such that a separation zone free of the gas shield is formed on the second gas ejection portion. Thus, the workpiece aligned with the separation zone will not be affected by the gas currents ejected from the plurality of gas ejection ports, which avoids the gas currents ejected from the plurality of gas ejection ports from interfering with the spraying gas currents acting on the workpiece.

In an example, each of the plurality of gas ejection ports of the second gas ejection portion has a flow passage. Each flow passage of the second gas ejection portion has a diffusion angle toward the gas ejection port of the second gas ejection portion. The diffusion angle is 30-90 degrees. Thus, each flow passage gradually expands toward the respective gas ejection port, such that the areas covered by the gas currents ejected from two adjacent gas ejection ports can overlap with each other, which reliably forms a gas shield to completely isolate the workpieces from the atmosphere.

In an example, the at least one gas ejection port of the second gas ejection portion includes a gas ejection port forming an annular opening configured to form a continuous gas shield for covering the plurality of workpieces. Thus, the gas ejection port can send out a continuous annular gas shield to further assure isolation of the plurality of workpieces from the atmosphere.

In an example, the at least one gas ejection port of the second gas ejection portion forms a C-shaped opening having two ends. The two ends have a spacing of 50-200 mm therebetween, such that a separation zone free of the gas shield is formed on the second gas ejection portion. Thus, the second gas ejection portion forms the separation zone free of the gas shield, which avoids the gas currents ejected from the plurality of gas ejection ports from interfering with the spraying gas currents acting on the workpieces.

In an example, the worktable includes a conveying unit configured to move the plurality of workpieces along a predetermined path. The conveying unit includes a plurality of fixing portions configured to position the plurality of workpieces. The plurality of fixing portions is aligned with the second gas ejection portion, such that the gas shield ejected by the second gas ejection portion covers the predetermined path. Thus, the conveying unit can be used to move the to-be-sprayed workpieces to align with the spraying member for proceeding with the spraying process and to move the to-be-sprayed workpieces away from the spraying member to enter the gas shield.

In an example, the worktable has a rotating axis. The conveying unit rotates about the rotating axis. The plurality of fixing portions is spacedly disposed in a circumferential direction about the rotating axis. Thus, the plurality of workpieces can be moved in the circumferential direction along the predetermined path to align with the spraying member for proceeding with the spraying process in sequence, and the workpieces before the spraying process can be located in the gas shield to isolate from the atmosphere.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a perspective view illustrating a gas shield protection device for thermal spraying of a first embodiment according to the present invention.

FIG. 2 is a front elevational view of a spraying member of the gas shield protection device for thermal spraying of the first embodiment according to the present invention.

FIG. 3 is a cross sectional view taken along section line 3-3 of FIG. 2.

FIG. 4 is a cross sectional view taken along section line 4-4 of FIG. 2.

FIG. 5 is an enlarged view of a circled portion of FIG. 4.

FIG. 6 is an enlarged view similar to FIG. 5, illustrating another example of a guiding face.

FIG. 7 is a front elevational view of a spraying member of the gas shield protection device for thermal spraying of a second embodiment according to the present invention.

FIG. 8 is a front elevational view of a gas shield generation device of the first embodiment according to the present invention.

FIG. 9 is a front elevational view of a gas shield generation device of the second embodiment according to the present invention.

FIG. 10 is a cross sectional view of an ejection port shown in FIG. 8.

FIG. 11 is a diagrammatic view illustrating formation of a gas shield during a spraying process of the first embodiment according to the present invention.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

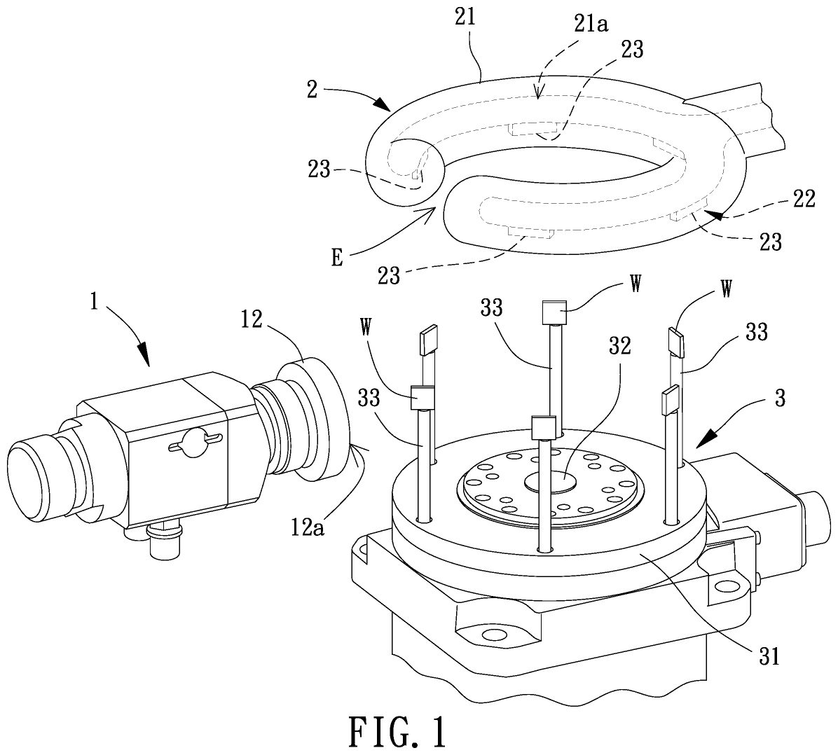

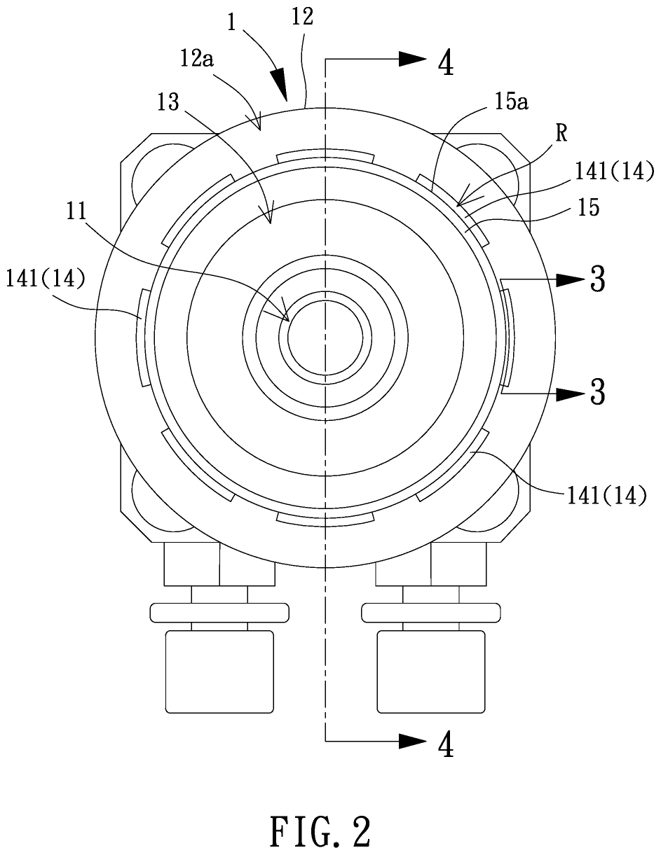

With reference to FIGS. 1 and 2, a gas shield protection device for thermal spraying of a first embodiment according to the present invention includes a spraying member 1 and a gas shield protection device 2. The spraying member 1 is configured to send out spraying gas currents to a workpiece W. The gas shield protection device 2 is configured to align with the workpiece W to send out gas currents to cover the workpiece W.

The spraying member 1 includes a nozzle 11 and a shield body 12 which may be disposed around the nozzle 11. The shield body 12 may be detachably mounted around the nozzle 11 or integrally formed around the nozzle 11. The present invention is not limited in this regard. The shield body 12 includes a through-hole 13 aligned with an opening of the nozzle 11. The shield body 12 includes an end face 12a on which the through-hole 13 is located. The through-hole 13 may be in the form of a circular opening or an opening having another geometric shape as long as not blocking the opening of the nozzle 11. Namely, the area of the opening of the through-hole 13 is greater than the area of the opening of the nozzle 11. Therefore, the spray material ejected from the nozzle 11 can be ejected through the through-hole 13.

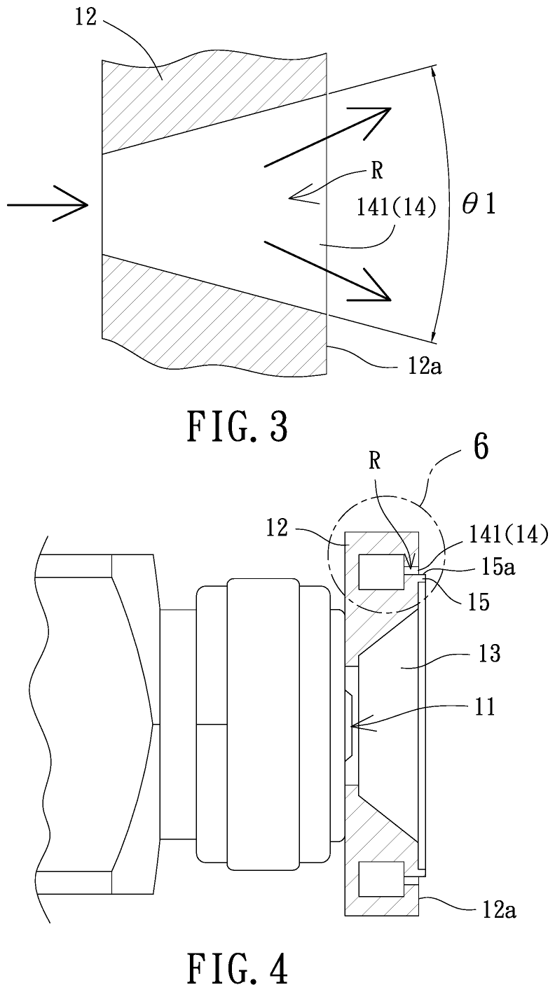

With reference to FIGS. 2 and 3, the gas shield portion 12 includes a first gas ejection portion 14 located on the end face 12a. The first gas ejection portion 14 is disposed around the through-hole 13 and is configured to eject a protective gas, such as an inert gas, such that the protective gas can surround the through-hole 13. The first gas ejection portion 14 may be connected to a pipeline disposed in a spraying member to supply the protective gas. Alternatively, the first gas ejection portion 14 may be connected to an external pipeline to supply the protective gas. This can be appreciated by one having ordinary skill in the art, and detailed description is not set forth to avoid redundancy. The first gas ejection portion 14 may include a plurality of gas ejection ports 141 disposed around the through-hole 13. In this embodiment, the through-hole 13 is a circular opening, and the plurality of gas ejection ports 141 extend in a circumferential direction about the through-hole 13. Furthermore, each gas ejection port 141 includes a flow passage R which has a diffusion angle θ1 toward the respective gas ejection port 141, and the diffusion angle θ1 may be 10-90 degrees. Thus, the areas of the gas currents ejected from two adjacent gas ejection ports 141 can overlap with each other to reliably form a gas shield which can completely isolate the through-hole 13 from the atmosphere.

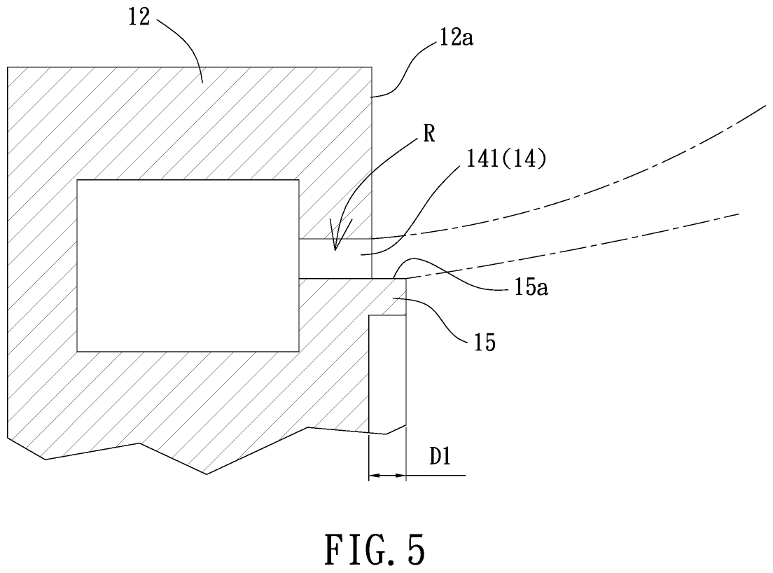

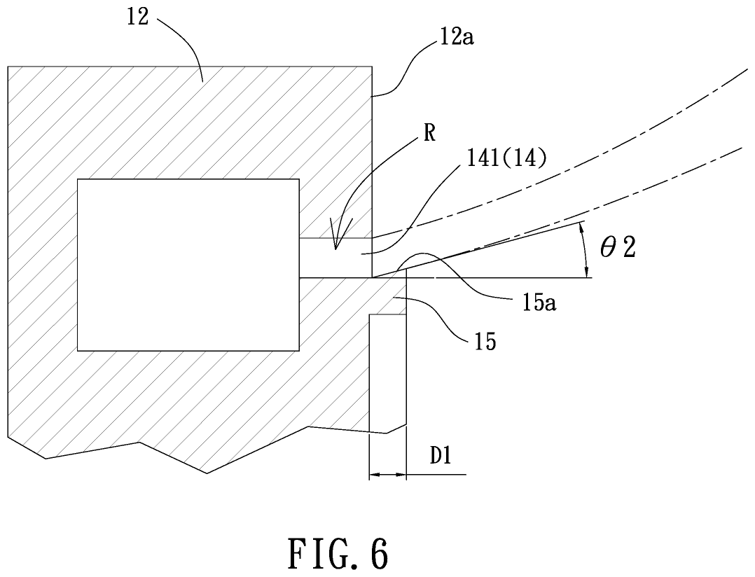

With reference to FIGS. 4 and 5, it is worth noting that the first gas ejection portion 14 includes at least one guiding protrusion 15 located between the gas ejection ports 141 and the through-hole 13. In this embodiment, the first gas ejection portion 14 includes a plurality of guiding protrusions 15 spaced from each other and aligned with the gas ejection ports 141, respectively. Thus, the gas currents ejected from the gas ejection ports 14 will not interfere with the path of the spray material ejected from the nozzle 11. Specifically, each guiding protrusion 15 protrudes from the end face 12a, and a protruding distance D1 of each guiding protrusion 15 protruding from the end face 12a may be at least 5 mm, such that each guiding protrusion 15 has a sufficient protruding distance D1 to guide the gas currents ejected from the respective gas ejection port 141. Each guiding protrusion 15 has a guiding face 15a located on a side of the guiding protrusion 15 facing the respective gas ejection port 141. The guiding face 15a may be contiguous to the gas ejection port 141, and the direction of the gas currents ejected from the gas ejection port 141 can be adjusted by the guiding face 15a. Namely, a gap exists between a gas wall formed by the gas currents ejected from the first ejection portion 14 via the guiding face 15a and the gas currents formed at the opening of the nozzle 11, such that the gas currents ejected from the first ejection portion 14 will not overlap with the path of the spray material ejected from the nozzle 11. As an example, the guiding face 15a extends perpendicularly to the end face 12a. Namely, the guiding face 15a is a vertical face relative to the gas ejection port 141, such that the gas currents ejected from the gas ejection port 14 can be guided by the guiding face 15a to move forward in a path parallel to the path of the spray material. In another embodiment, given the guiding face 15a perpendicular to the end face 12a, the guiding face 15a has an inclination angle θ2 toward the gas ejection port 141, and the inclination angle θ2 may be 5-45 degrees, as shown in FIG. 6. Thus, the gas currents ejected from the gas ejection ports 21 can be guided by the guiding face 15a to deviate from the path of the spray material.

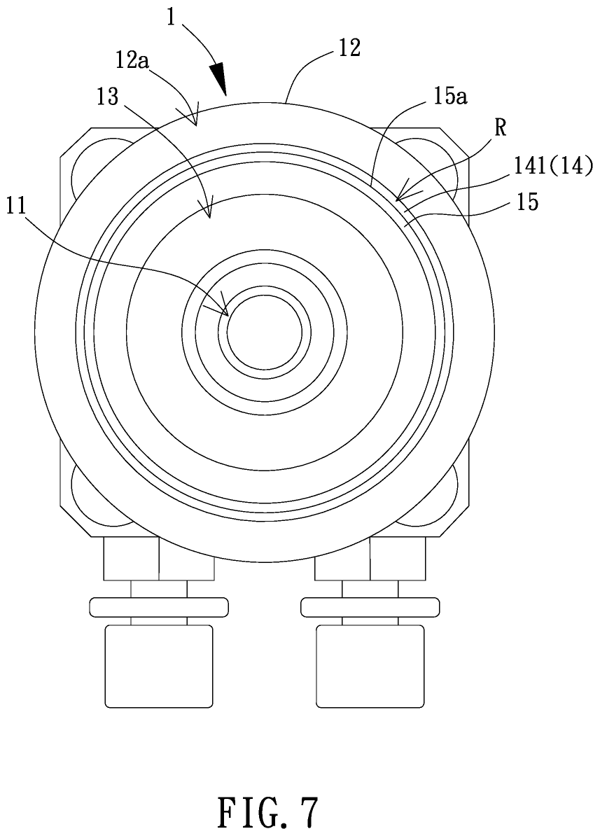

With reference to FIG. 7 showing another embodiment of the shield body 12, in this embodiment, the first gas ejection portion 14 includes a single gas ejection port 141 disposed around the through-hole 13, thereby forming an annular opening. Thus, the gas ejection port 141 can send out an annular gas shield around the through-hole 13 to further assure isolation of the through-hole 13 from the atmosphere.

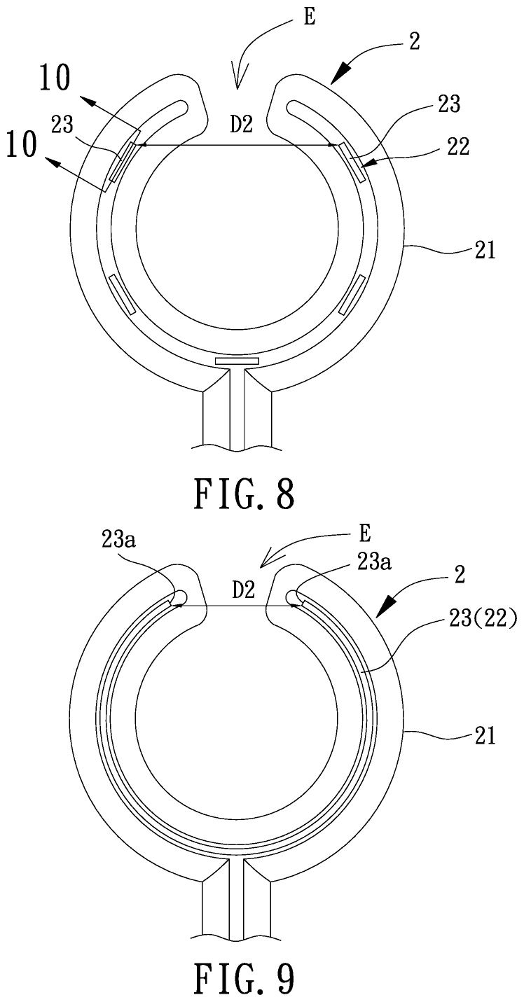

With reference to FIGS. 1 and 8, the gas shield generation device 2 includes a housing 21 and a second gas ejection portion 22. The second gas ejection portion 22 is located on a surface of the housing 21. The second gas ejection portion 22 is configured to align with the workpieces W.

The outline of the housing 21 is not limited. The housing 21 may have an appropriate outline according to the alignment requirement with the position of the workpieces W. For example, the hosing 21 is aligned with the workpieces W which are arranged annularly. Thus, the housing 21 may be substantially annular to align with the workpieces W from above. The housing 21 has a gas passageway 21a therein. The gas passageway 21a may be connected to a gas source, such that the gas source may supply a protective gas, such as an inert gas, to the gas passageway 21a.

With reference to FIGS. 8 and 9, the second gas ejection portion 22 has at least one gas ejection port 23 intercommunicating with the gas passageway 21. Thus, the at least one gas ejection port 23 may eject a protective gas, such as an inert gas, which may cover the workpieces W. In this embodiment, the second gas ejection portion 22 has a plurality of gas ejection ports 23 which may align with the plurality of workpieces W, respectively. The plurality of gas ejection ports 23 may be spaced from each other. For example, the plurality of ejection ports 23 may be substantially arranged in an annular path according to the outline of the housing 21. Therefore, the protective gas outputted from the plurality of ejection ports 23 may cover a substantially annular area.

It is worth noting that the spacing D2 between two adjacent gas ejection ports 23 of the second gas ejection portion 23 may be 50-200 mm, such that a separation zone E having a long distance and without overlapped gas shields is formed between the two gas ejection ports 23. Namely, the workpiece W aligned with the separation zone E will not be covered by the protective gas ejected from the gas ejection ports 23. Therefore, the workpiece W aligned with the separation zone E will not be affected by the gas currents ejected from the gas ejection ports 23. This may avoid the gas currents ejected from the gas ejection ports 23 from interfering with the spraying gas currents ejected from the spraying member 1.

In another embodiment of the gas shield generation device 2, the second gas ejection portion 22 may include a single ejection port 23 which may form a substantially annular opening according to the outline of the housing 21, as shown in FIG. 9. Thus, the gas ejection port 23 may send out a continuous annular gas shield to further assure isolation of the plurality of workpieces W from the atmosphere. Furthermore, the gas ejection port 23 of the second gas ejection portion 22 may form a C-shaped opening having two ends 23a. The two ends 23a may have the spacing D2 of 50-200 mm therebetween, such that a separation zone E free of the gas shield is formed on the second gas ejection portion 22.

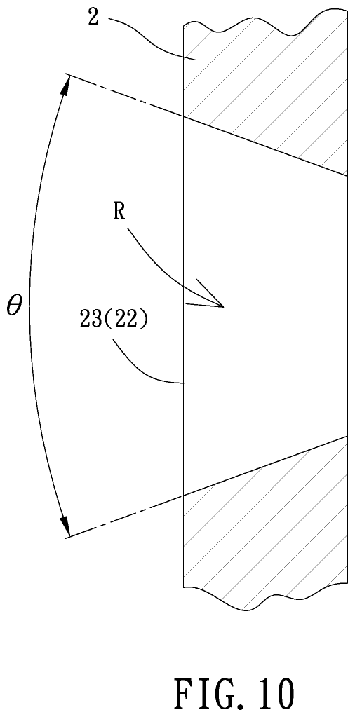

With reference to FIG. 10, each of the plurality of gas ejection ports 23 of the second gas ejection portion 22 has a flow passage R. Each flow passage R has a diffusion angle θ toward the gas ejection port 23. The diffusion angle θ may be 30-90 degrees. Therefore, the areas covered by the gas currents ejected from two adjacent gas ejection ports 23 can overlap with each other, which reliably forms a gas shield to completely isolate the plurality of workpieces W from the atmosphere.

With reference to FIG. 1, the gas shield protection device for thermal spraying according to the present invention may further include a worktable 3 including a conveying unit 31 configured to move the plurality of workpieces W along a predetermined path. The conveying unit 31 may be a conveying belt or a rotary table and may be driven by such as a track and a motor to actuate the conveying unit 31. Furthermore, the worktable 3 has a rotating axis 32. The conveying unit 31 rotates about the rotating axis 32. The conveying unit 31 includes a plurality of fixing portions 33 which may be fixing holes or fixing frames. The plurality of fixing portions 33 is configured to position the plurality of workpieces W. The plurality of fixing portions 33 is spacedly disposed in a circumferential direction about the rotating axis 32. Thus, the plurality of fixing portions 33 can move in a circumferential direction along a predetermined path. The plurality of fixing portions 33 is aligned with the second gas ejection portion 22, such that the gas shield ejected by the second gas ejection portion 22 covers the predetermined path. Thus, the workpiece W may be fixed to one of the plurality of fixing portions 33. The conveying unit 31 actuates the workpiece W to move in a circumferential path to send the workpiece W into the gas shield for isolation from the atmosphere.

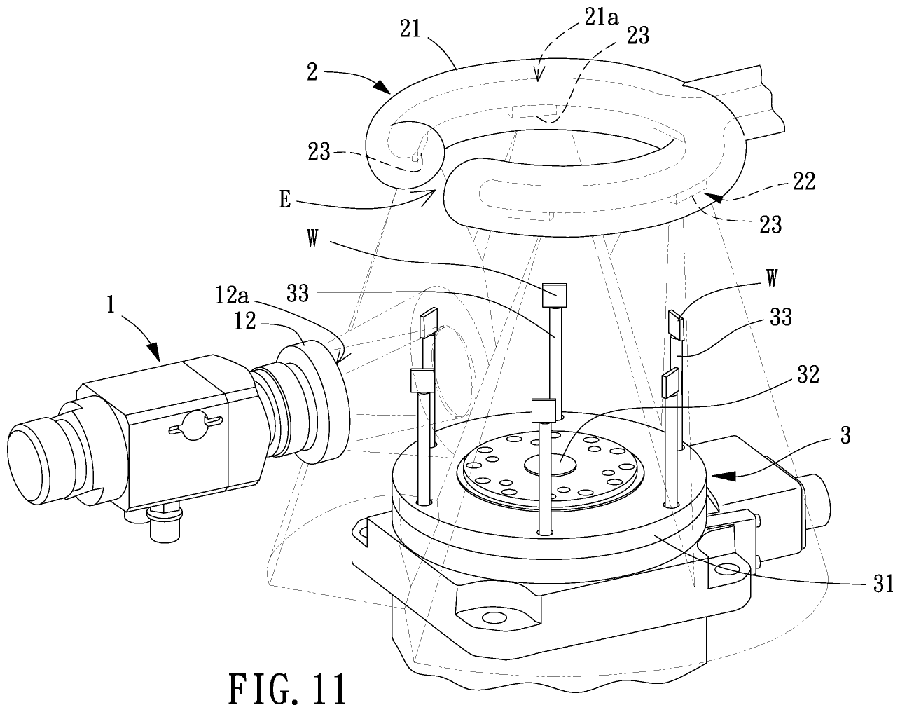

With reference to FIG. 11, in use of the gas shield protection device for thermal spraying according to the present invention, the through-hole 13 of the shield body 12 is aligned with the workpiece W. When the spraying member 1 proceeds with spraying on the workpiece W, the spray material can pass through the through-hole 13 to form a spraying path. The protective gas can be sent out through the first gas ejection portion 14 around the through-hole 13 to form a gas shield around the spraying path. Furthermore, since the second gas ejection portion 22 on the gas shield generation device 2 is aligned with the workpiece W from above, the protective gas sent out through the second gas ejection portion 22 can form a gas shield surrounding the workpiece W. Therefore, when the spraying member 1 proceeds with intermittent spraying on the workpiece W at an interval, the workpiece W may be covered by the protective gas sent out from the second gas ejection portion 22 during the interval and, thus, can be isolated from the atmosphere, thereby avoiding oxidation of the coating. Furthermore, the workpiece W can be fixed on the worktable 3 and can be actuated by the conveying unit 31 to move in the predetermined path. Thus, the conveying unit 31 can move the workpiece W to align with the spraying member to proceed with the spraying process and can move the workpiece W away from the spraying member 1 to enter the gas shield. Furthermore, a plurality of workpieces W can be fixed on the worktable 3 and can be moved along the predetermined path to sequentially align with the spraying member 1 for proceeding with the spraying process, and the workpieces W before the spraying process can be located in the gas shield and, thus, can be isolated from the atmosphere. Therefore, the spraying path can be isolated from the atmosphere to avoid oxidation of the coating on the workpieces W.

In view of the foregoing, in the gas shield protection device for thermal spraying according to the present invention, by providing the first gas ejection portion having at least one guiding protrusion located between the at least one gas ejection port and the through-hole, such that the at least one guiding protrusion forms the guiding face with respect to the at least one gas ejection port. The guiding face permits the path of the gas currents ejected from the at least one gas ejection port to be parallel to or deviate from the path of the spray material. This avoids the path of the gas currents ejected from the at least one gas ejection port from interfering with the path of the spray material, thereby achieving better spraying accuracy. Furthermore, the second gas ejection portion can generate a protective gas to cover the workpieces, such that the workpieces before the spraying process can be temporarily located in the gas shield and, thus, can be isolated from the atmosphere, thereby avoiding oxidation of the coating on the workpieces.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims. Furthermore, in a case that several of the above embodiments can be combined, the present invention includes the implementation of any combination.

What is claimed is:

1. A gas shield protection device for thermal spraying, comprising:
a spraying member including a nozzle and a shield body disposed on the nozzle, wherein the nozzle is configured to align with one of a plurality of workpieces on a worktable, wherein the shield body includes an end face having a through-hole aligned with an opening of the nozzle, wherein a first gas ejection portion is disposed around the through-hole and includes at least one gas ejection port located on the end face, wherein the first gas ejection portion includes at least one first guiding protrusion located between the at least one gas ejection port and the through-hole, wherein the at least one guiding protrusion has a guiding face located on a side of the at least one guiding protrusion facing the at least one gas ejection port, wherein the guiding face a is configured to avoid gas currents ejected from the first gas ejection portion from overlapping with a path of a spray material ejected from the opening of the nozzle; and
a gas shield generation device configured to align with the worktable, wherein the gas shield generation device includes a housing and a second gas ejection portion, wherein the housing has a gas passageway therein, wherein the second gas ejection portion has at least one gas ejection port intercommunicating with the gas passageway, wherein the at least one gas ejection port is configured to face the plurality of workpieces, such that an area of a gas shield ejected from the at least one gas ejection port of the second gas ejection portion covers the plurality of workpieces.

2. The gas shield protection device for thermal spraying as claimed in claim 1, wherein the at least one gas ejection port of the first gas ejection portion includes a plurality of gas ejection ports disposed around the through-hole and spaced from each other.

3. The gas shield protection device for thermal spraying as claimed in claim 2, wherein each of the plurality of gas ejection ports of the first gas ejection portion has a flow passage, wherein each flow passage of the first gas ejection portion has a diffusion angle toward a respective gas ejection port, and wherein the diffusion angle is 10-90 degrees.

4. The gas shield protection device for thermal spraying as claimed in claim 1, wherein the at least one gas ejection port of the first gas ejection portion includes an annular gas ejection port disposed around the through-hole to form an annular opening.

5. The gas shield protection device for thermal spraying as claimed in claim 1, wherein a protruding distance of the at least one guiding protrusion protruding from the end face is at least 5 mm.

6. The gas shield protection device for thermal spraying as claimed in claim 1, wherein the guiding face extends perpendicularly to the at least one gas ejection port of the first gas ejection portion.

7. The gas shield protection device for thermal spraying as claimed in claim 1, wherein the guiding face has an inclination angle toward the at least one gas ejection port of the first gas ejection portion, and wherein the inclination angle is 5-45 degrees.

8. The gas shield protection device for thermal spraying as claimed in claim 1, wherein the at least one gas ejection port of the second gas ejection portion includes a plurality of gas ejection ports spaced from each other, and wherein two gas shields ejected from two adjacent gas ejection ports of the second gas ejection portion overlap with each other.

9. The gas shield protection device for thermal spraying as claimed in claim 8, wherein a spacing between two adjacent gas ejection ports of the second gas ejection portion is 50-200 mm, such that a separation zone free of the gas shield is formed on the second gas ejection portion.

10. The gas shield protection device for thermal spraying as claimed in claim 1, wherein each of the plurality of gas ejection ports of the second gas ejection portion has a flow passage, wherein each flow passage of the second gas ejection portion has a diffusion angle toward the gas ejection port of the second gas ejection portion, and wherein the diffusion angle is 30-90 degrees.

11. The gas shield protection device for thermal spraying as claimed in claim 1, wherein the at least one gas ejection port of the second gas ejection portion includes a gas ejection port forming an annular opening configured to form a continuous gas shield for covering the plurality of workpieces.

12. The gas shield protection device for thermal spraying as claimed in claim 1, wherein the at least one gas ejection port of the second gas ejection portion forms a C-shaped opening having two ends, wherein the two ends have a spacing of 50-200 mm therebetween, such that a separation zone free of the gas shield is formed on the second gas ejection portion.

13. The gas shield protection device for thermal spraying as claimed in claim 1, wherein the worktable includes a conveying unit configured to move the plurality of workpieces along a predetermined path, wherein the conveying unit includes a plurality of fixing portions configured to position the plurality of workpieces, wherein the plurality of fixing portions is aligned with the second gas ejection portion, such that the gas shield ejected by the second gas ejection portion covers the predetermined path.

14. The gas shield protection device for thermal spraying as claimed in claim 13, wherein the worktable has a rotating axis, wherein the conveying unit rotates about the rotating axis, and wherein the plurality of fixing portions is spacedly disposed in a circumferential direction about the rotating axis.
